(19) United States
(12) Patent Application Publication
(10) Pub. No.: US 2021/0011895 A1
(43) Pub. Date: Jan. 14, 2021

(54) HIERARCHICAL DOCUMENT SECTIONING FOR CONTEXTUAL RETRIEVAL

(71) Applicant: LONGSAND LIMITED, Cambridge (GB)

(72) Inventors: Sean Mark BLANCHFLOWER, Cambridge (GB); Brian Gibson COWE, Cambridge (GB)

(73) Assignee: LONGSAND LIMITED, Cambridge (GB)

(21) Appl. No.: 16/509,251

(22) Filed: Jul. 11, 2019

(51) Int. Cl. G06F 16/22; G06F 16/93; G06F 16/23; G06F 16/245

(52) U.S. Cl. CPC G06F 16/2246; G06F 16/245; G06F 16/2379; G06F 16/93

(57) ABSTRACT

According to examples, an apparatus may include a processor that may divide content of a document to be indexed into sections. The apparatus may divide and arrange each section into a hierarchy based on linguistic, spatial, or other analysis. The apparatus may identify a context of each section that may provide an indication of the subject matter of the section. The apparatus may add the context to downstream sections in the hierarchy. The apparatus may generate an index entry for each section based on the content of the section and any added context from upstream sections. Thus, the index entry for a given section may be based on the context of the given section and context of upstream sections in the hierarchy. In this way, the index entries may account for not only the content of the given section, but also context from upstream sections.

### BACKGROUND

An electronic document search and retrieval system may search for and retrieve a document, from among a corpus of documents, that may be relevant to a search query. Because the corpus of documents may be large, searching through each document to perform search and retrieval may be inefficient. Thus, the system may instead generate a document index based on the contents of each document in the corpus of documents. The document index may be based on keywords or other portion of the content of each document. A given index entry in the document index may correspond to the document from which the index entry was generated. The system may search the document index to identify relevant content and a corresponding document that includes the relevant content. In this manner, relevant documents may be found by searching the document index rather than the corpus of documents.

### BRIEF DESCRIPTION OF THE DRAWINGS

Features of the present disclosure may be illustrated by way of example and not limited in the following figure(s), in which like numerals indicate like elements, in which:

FIG. 1 shows a block diagram of an example apparatus that may divide a document into hierarchical sections for document retrieval;

FIG. 2A shows an example of an arrangement of a document in hierarchy having hierarchical sections;

FIG. 2B shows an example of an arrangement of a document having linear sections;

FIG. 3A shows a diagram of a document being divided into hierarchical sections and maintaining context of previous sections for indexing through execution of example divider instructions;

FIG. 3B shows a diagram of a document being divided into linear sections and maintaining context of previous sections for indexing through execution of example divider instructions;

FIG. 4A shows a diagram of hierarchical sections being indexed with the context of previous sections through execution of example indexing instructions;

FIG. 4B shows a diagram of linear sections being indexed with the context of previous sections through execution of example indexing instructions;

FIG. 5 depicts a flow diagram of an example method for searching a document index that includes index entries that were generated based on document sectioning and contextual information; and

FIG. 6 depicts a block diagram of an example non-transitory machine-readable storage medium for indexing a document having sections that maintain context of previous sections.

### DETAILED DESCRIPTION

For simplicity and illustrative purposes, the present disclosure may be described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. Throughout the present disclosure, the terms “a” and “an” may be intended to denote at least one of a particular element. As used herein, the term “includes” means includes but not limited to, the term “including” means including but not limited to. The term “based on” means based at least in part on.

Although a document index may speed up search and retrieval, there may be issues with indexing documents having different lengths relative to one another. For example, a document retrieval system may search a 50-page document based on an index entry generated from all 50 pages. If a search term matches only one page, the document retrieval system may determine that the document as a whole is irrelevant even though the matching page may be highly relevant to the search term. On the other hand, the document retrieval system may determine that a two-page document whose index has a match with the search term is relevant. Although the two-page document may be relevant and properly included in search results, the document retrieval system may erroneously omit the 50-page document from the search results.

Some systems may segment the document into individual pages and index the individual pages. This technique may permit individual pages of the document to be indexed and searched. However, segmenting the document in this manner may introduce problems in which contextual information from previous sections of the document may be lost. For example, a sub-chapter within a chapter of a novel segmented according to this technique may lose the contextual information of the chapter. Individual pages in the sub-chapter may lose the contextual information of the sub-chapter, and so on. The issues of variable-length documents and sectioning documents for indexing may result in erroneous or incomplete search results, which may also result in repeated searches, wasting computational and energy resources.

Disclosed herein are apparatuses and methods for dividing content of a document to be indexed into sections while preserving contextual information of upstream (previous) sections. For example, an apparatus, which may be part of a document retrieval system, may arrange each section in a hierarchy based on linguistic, spatial, or other analysis. In some examples, the apparatus may linguistically analyze the text of the content to identify sections (and section boundaries) based on related (or not related) subject matter. In some examples, the apparatus may spatially analyse the content to identify section boundaries based on content spacing such as page number, paragraph, or sentences. In some examples, the apparatus may divide the content in other ways as well, such as based on native document sections or text formatting.

During or after dividing of the document into sections, the apparatus may identify a context of each section. The context may include only a portion of the content in the section while providing an indication of the subject matter of the section. For example, the context may include the beginning words, sentences, paragraphs, or other portion of the content in the section. The apparatus may add the context to downstream sections so that each of the downstream sections inherit the context of an upstream section. The apparatus may generate an index entry for each section based on the content of the section and any added context from upstream sections. Thus, the index entry for a given section may be based on the context of the given section and the context of upstream sections in the hierarchy. In this way, searching for search terms in a given section based on the index entries may account for not only the content of the given section, but also contextual information from upstream sections. As such, the apparatus may mitigate the effects of searching variable-length documents in which the size of the document may skew relevance scoring. Thus, the apparatus may improve the relevance and accuracy of search results, reducing the waste of computational and energy resources that may result from inaccurate or incomplete search results.

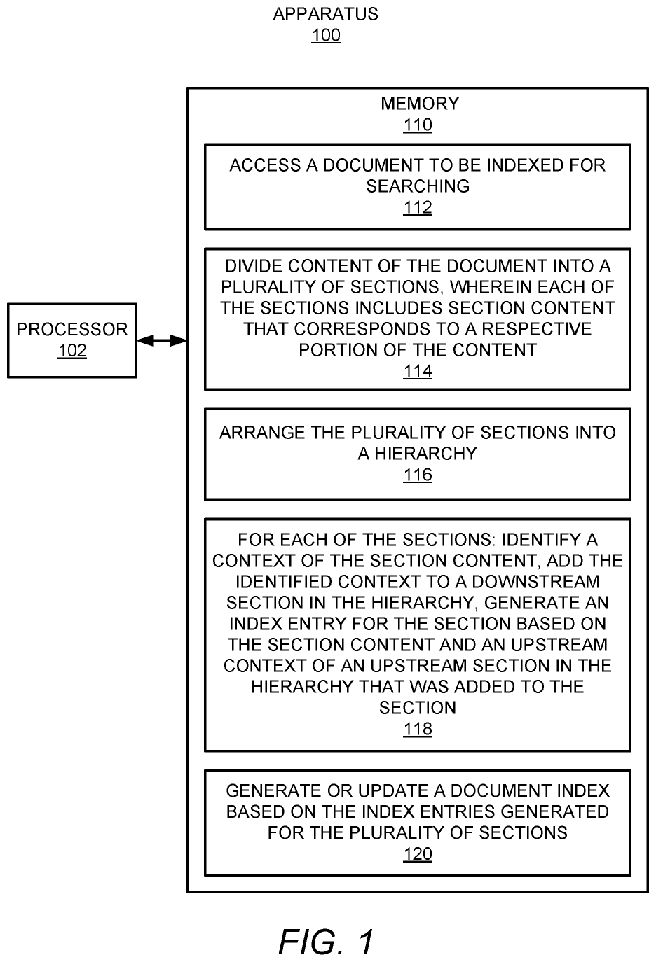

Reference is first made to FIG. 1, which shows a block diagram of an example apparatus that may divide a document into hierarchical sections for document retrieval. It should be understood that the example apparatus 100 depicted in FIG. 1 may include additional features and that some of the features described herein may be removed and/or modified without departing from any of the scopes of the example apparatus 100. The apparatus 100 shown in FIG. 1 may be a computing device, a server, or the like. As shown in FIG. 1, the apparatus 100 may include a processor 102 that may control operations of the apparatus 100. The processor 102 may be a semiconductor-based microprocessor, a central processing unit (CPU), an application specific integrated circuit (ASIC), a field-programmable gate array (FPGA), and/or other suitable hardware device. Although the apparatus 100 has been depicted as including a single processor 102, it should be understood that the apparatus 100 may include multiple processors, multiple cores, or the like, without departing from the scopes of the apparatus 100 disclosed herein.

The apparatus 100 may include a memory 110 that may have stored thereon machine-readable instructions (which may also be termed computer readable instructions) 112-120 that the processor 102 may execute. The memory 110 may be an electronic, magnetic, optical, or other physical storage device that includes or stores executable instructions. The memory 110 may be, for example, Random Access memory (RAM), an Electrically Erasable Programmable Read-Only Memory (EEPROM), a storage device, an optical disc, and the like. The memory 110 may be a non-transitory machine-readable storage medium, where the term “non-transitory” does not encompass transitory propagating signals.

Referring to FIG. 1, the processor 102 may fetch, decode, and execute the instructions 112 to access a document to be indexed for searching. For example, the document is to be added to an indexed corpus of documents or otherwise has not yet indexed by the apparatus 100 for searching. The document may be an electronic file that is storable on a storage device, such as memory 110, and may encode words or phrases that may be searched using keywords or other search terms of a search query. For example, the document may include an electronic novel, an electronic financial report, a webpage (such as a hyper-text markup language (HTML) document), and/or other electronic document that encodes words or phrases. It should be understood that the particular electronic format of the document may not be important, so long as the processor 102 is able to access words, phrases, or other text from the electronic format. For example, the document may be in a portable document format, a word processing format, an HTML format, and/or other electronic format that the processor 102 may access. For examples in which text is not electronically encoded (based on ASCII or other text encoding or metadata), such as images that include text or portable document formats that do not include text metadata, the processor 102 may pre-process the document to recognize text. For example, the processor 102 may perform optical character recognition or other text analysis to recognize text from such documents.

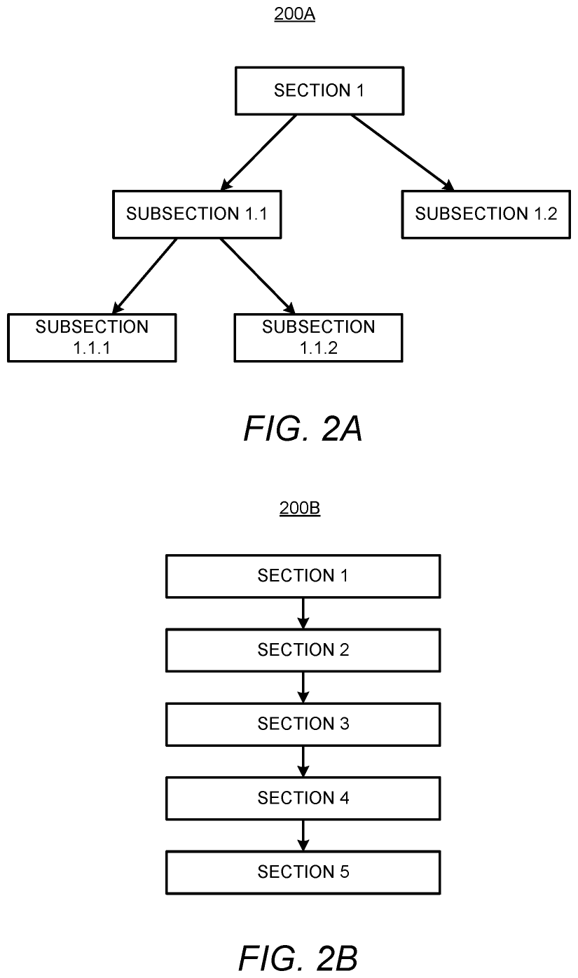

The processor 102 may fetch, decode, and execute the instructions 114 to divide content of the document into a plurality of sections. Each section of the plurality of sections may include section content (a portion of the content of the document corresponding to the section). In some examples, the processor 102 may divide the content according to a hierarchy, as illustrated in FIG. 2A. FIG. 2A shows an example of an arrangement of a document in a hierarchy 200A having hierarchical sections (sections 1, subsections 1.1, 1.1.1, 1.1.2, and 1.2). The hierarchy 200A may include a tree-like hierarchy in which sections of a document may be arranged as leaf nodes on branches. A section lower in the hierarchy 200A may be downstream on a branch from a section higher in the hierarchy. Put another way, a section higher in the hierarchy 200A may be upstream on a branch from a section lower in the hierarchy. For example, subsection 1.1.1 may be downstream of (after) subsection 1.1 on a branch. Subsection 1.1 may be downstream of (after) section 1. Put another way, section 1 may be upstream of (before or previous to) subsection 1.1 on the branch. Section 1.1 may be upstream of subsection 1.1.1 on the branch. It should be noted that subsection 1.1.1 may not be considered downstream of subsection 1.2 on the branch because subsection 1.2 is not on the same branch as subsection 1.1.1.

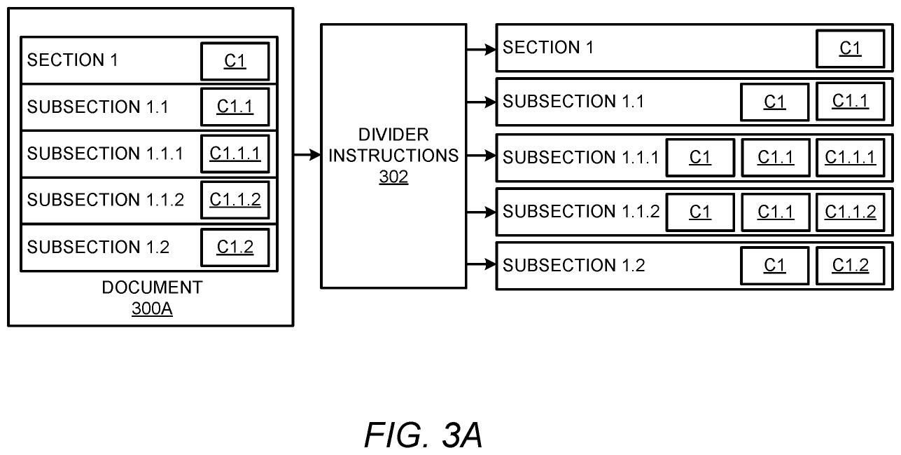

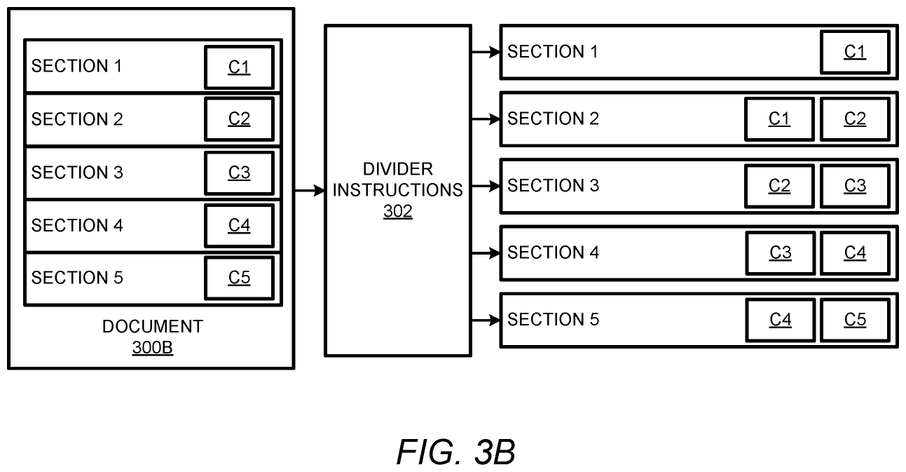

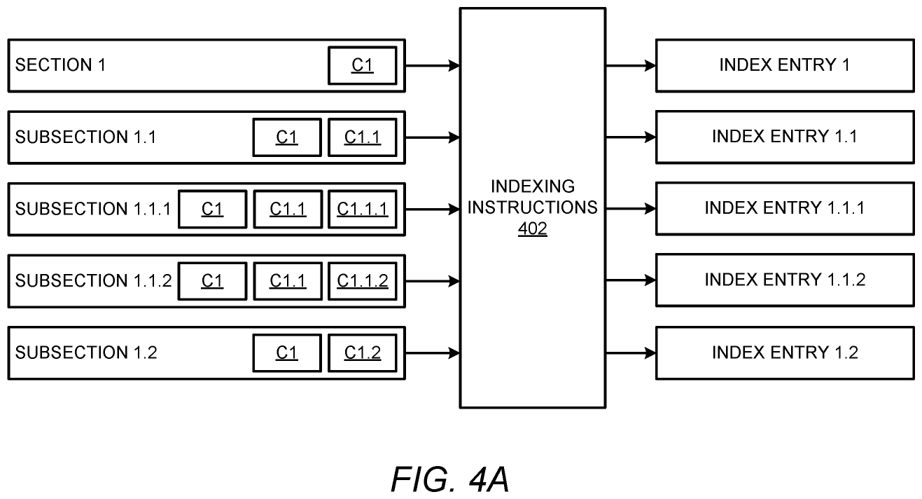

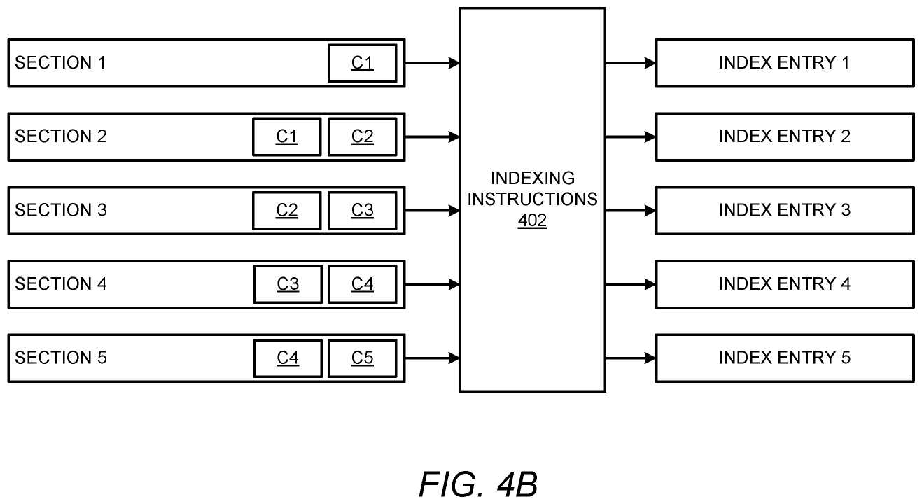

In some examples, the processor 102 may divide the content according to linear sections, as illustrated in FIG. 2B. FIG. 2B shows an example of an arrangement 200B of a document having (divided into) linear sections. In some examples, when the document is not arranged hierarchically or the processor 102 cannot otherwise ascertain such hierarchy, the processor 102 may divide the document into linear sections 1-5. Other numbers of sections may be used as well. Dividing the content into the hierarchy 200A and/or arrangement 200B and adding context from previous sections for contextual indexing and retrieval based on document sectioning will be described in more detail with respect to FIGS. 3A, 3B, 4A, and 4B.

The processor 102 may fetch, decode, and execute the instructions 116 to arrange the plurality of sections into a hierarchy. For example, the processor 102 may arrange the sections into a hierarchy 200A illustrated in FIG. 2A. The processor 102 may arrange the sections into the hierarchy 200A based on explicit metadata or other express indicators of the hierarchy (such as a hierarchical numbered list). In other instances, the processor 102 may use linguistic processing (such as through semantic similarity or relatedness scores) to cluster groups of content into branches. Alternatively, in some examples, if the document is not structured into a hierarchy 200A or the hierarchy is not discernible, the processor 102 may arrange the sections in an arrangement 200B illustrated in FIG. 2B.

The processor 102 may fetch, decode, and execute the instructions 118 to, for each section of the plurality of sections, identify a context of the section content, add the identified context to a downstream section in the hierarchy, and generate an index entry for the section based on the section content and an upstream context of an upstream section in the hierarchy that was added to the section.

The processor 102 may fetch, decode, and execute the instructions 120 to generate or update a document index based on the index entries generated for the plurality of sections. The document index may include index entries for multiple documents that have been sectioned and indexed as described herein. As such, the apparatus 100 may section and index documents to be searched. For example, the processor 102 may access a search term to conduct a search of relevant documents, search the document index based on the search term, identify a matching index entry based on the search, provide a matching portion of matching content that corresponds to the matching index entry as a search result. The search result may also include a document identifier that identifies the document corresponding to the matching index entry. Thus, each index entry may be associated with a corresponding document and section of the document.

FIG. 3A shows a diagram of a document being divided into hierarchical sections (corresponding to the hierarchy 200A illustrated in FIG. 2A) and maintaining context of previous sections for indexing through execution of example divider instructions 302. FIG. 3A depicts divider instructions 302, which may cause a processor, such as processor 102 illustrated FIG. 1, to divide a document 300A into various sections (section 1, subsections 1.1, subsection 1.2, subsections 1.1.1, and subsections 1.1.2; hereinafter “sections 1-1.1.2” for convenience). For example, the divider instructions 302 may cause the processor to spatially divide the content, apply linguistic analysis to divide the content, use metadata information to divide the content, and/or otherwise divide the content of the document 300A into sections 1-1.1.2.

In some examples, to divide the content of the document into the plurality of sections, the divider instructions 302 may cause the processor to spatially divide the content of the document. In some examples, to spatially divide the content, the divider instructions 302 may cause the processor to may divide the document (content of the document) based on spacing, a page number, a paragraph number, or a sentence number of the content.

For example, the divider instructions 302 may cause the processor to spatially divide the content based on document spacing, which may indicate an organization of the document. In this example, the divider instructions 302 may cause the processor to identify differential spacing such as a double space in a document having single-spaced text. The divider instructions 302 may cause the processor to use the double space as a section boundary, which may separate sections of the document. In another example, the divider instructions 302 may cause the processor to spatially divide the content into sections based on individual pages. In this example, the divider instructions 302 may cause the processor to identify individual pages by obtaining page numbering metadata from the document and/or parsing page numbers within text of the document and use the page numbers as section boundaries. In another example, the divider instructions 302 may cause the processor to spatially divide the content into sections based on individual paragraphs. In this example, the divider instructions 302 may cause the processor to identify paragraphs based on the non-existence of carriage return or other newline indicators over multiple lines of text, and use the paragraphs as sections. In still another example, the divider instructions 302 may cause the processor to spatially divide the content into sections based on individual sentences of text. In these examples, the divider instructions 302 may cause the processor to identify sentences based on strings of text, period symbol (or other sentence ending symbol), and capital letters (or other indicates of the beginning of a next sentence).

In some examples, in addition to or instead of spatially dividing the content, the divider instructions 302 may cause the processor to divide the content based on text analysis. For example, to analyze the text of the document, the divider instructions 302 may cause the processor to identify related sub-topics based on words or phrases of the text of the content to identify related sections and boundaries between the related sections. In these examples, the divider instructions 302 may cause the processor to perform natural language processing or other linguistic analysis to determine the subject matter of the text of a portion of the content. For instance, the divider instructions 302 may cause the processor to analyze each sentence (or other set portion of the content) to determine the subject matter of the sentence and may determine that the subject matter is related (or not related) to a previous subject matter of a previous sentence. In particular, the divider instructions 302 may cause the processor to determine a similarity or relatedness metric that determines a similarity or relatedness between the sentences (or other sets of words of the content). For example, the divider instructions 302 may cause the processor to determine a semantic similarity score that indicates a distance between the meaning or nature of the sentences. Likewise, the divider instructions 302 may cause the processor to determine a semantic relatedness score that indicates whether the two sentences are related or not. Non-limiting examples of similarity metrics may include marker-passing, good common subsume (GCS) based semantic similarity, and/or other similarity metrics analysis. Depending on the similarly or relatedness metric, the divider instructions 302 may cause the processor to classify the sentences as belonging to the same section, a related section, or a different section. It should be noted that other types of similarity metrics, including statistics-based text analysis may be used as well, such as latent semantic analysis, normalized compression distance, and/or other statistical similarity techniques.

In some examples, to divide the content, the divider instructions 302 may cause the processor to identify native document structure indicators used by the document. For example, some documents may include native document structure indicators such as a number list, bullet list, multi-level lists, headings and sub-headings, table of contents, paragraph breaks, section breaks, and/or document structure indicators. Some documents may include native document structure indicators such as markup metadata (e.g., extensible markup language) that tags individual sections. The processor 102 may use such native document structure indicators to divide the content. In some examples, to divide the content, the divider instructions 302 may cause the processor to identify text formatting that indicates an organization of the document. For example, the processor 102 may recognize bold, underline, or other differentially formatted text to identify section boundaries.

The content of each section may include contextual information, or context (C1, C1.1, C1.2, C1.1.1, and C1.1.2; hereinafter, “context C1-C1.1.2” for convenience). Each context C1-C1.1.2 may indicate a subject matter of a corresponding section. For example, context C1 may include context of section 1, context C1.1 may include context of subsection 1.1, context C1.2 may include context of subsection 1.2, context C1.1.1 may include context of subsection 1.1.1, and context C1.1.2 may include context of subsection 1.1.2.

During or after dividing the content into sections 1-1.1.2, the divider instructions 302 may cause the processor to identify the context of a given section being analyzed and add the context to a next (downstream) section in the hierarchy. To identify the context of a given section, the divider instructions 302 may cause the processor to identify a title of section, identify beginning portions (such as first N pages, paragraphs, sentences, words, etc., where N is a predefined number) of the given section, identify keywords in the given section, and/or otherwise identify portions of section content that provides context of the subject matter of the section.

To illustrate, the divider instructions 302 may cause the processor to identify first context from section 1 and add the first content to a downstream section (subsection 1.1). Likewise, the divider instructions 302 may cause the processor to identify second context from subsection 1.1 and add the second context to subsection 1.1.1. It should be noted that the divider instructions 302 may cause the processor to add the first context from section 1 to subsection 1.2, but not add the context from subsection 1.2 to subsection 1.1.1 because subsections 1.2 and 1.1.1 may not be on the same branch in the hierarchy 200A illustrated at FIG. 2A. In some examples, the divider instructions 302 may cause the processor to add the identified context to downstream sections in the hierarchy. In these examples, the index entry for the section may be based on the section content and the upstream context of upstream sections in the hierarchy. For example, the divider instructions 302 may cause the processor to add the first context from section 1 to all downstream sections in a branch. In particular, the divider instructions 302 may cause the processor to add the first context from section 1 to subsection 1.1.1 and subsection 1.1.2 (in addition to subsection 1.1). Likewise, in this example, the divider instructions 302 may cause the processor to add the second context from section 1.1 to subsections 1.1.1 and subsections 1.1.2 (but not to subsection 1.2 since subsection 1.2 is not downstream of subsection 1.1 on a branch). In this manner, the divided sections 1-1.1.2 may each include the context of upstream sections in the hierarchy, thereby maintaining contextual information from the upstream sections.

FIG. 3B shows a diagram of a document being divided into linear sections and maintaining context of previous sections for indexing through execution of example divider instructions 302. In the example illustrated in FIG. 3B, the divider instructions 302 may cause the processor to divide the content a manner similar to that described with respect to FIG. 3A, except that instead of adding context of a section to downstream sections in a hierarchy 200A, the divider instructions 302 may cause the processor to divide the content of a document 300B based on an arrangement 200B. For example, because of the linear sectioning, the divider instructions 302 may add contextual information (C1-C5) of a current section to a next section in the arrangement 200A. Thus, a given section other than a top-level section (sections 2-5) may have only two contexts for indexing purposes: the context of the current section and the context of a previous section.

Other maximum numbers (or no maximum number such that each section has the context of all prior sections) of context per section may be retained as well. For example, a given section may include the context of the given section and two (or other number of) prior sections. It should be noted that the divider instructions 302 illustrated in FIGS. 3A and 3B may include some or all of the instructions 112-120 illustrated in FIG. 1, instructions that facilitate the operations illustrated in FIGS. 4A, 4B, 5 and 6, and/or other instructions.

FIG. 4A shows a diagram of hierarchical sections being indexed with the context of previous sections through execution of example indexing instructions 402. FIG. 4A depicts indexing instructions 402, which may cause a processor, such as processor 102 illustrated FIG. 1, to generate an index entry for each content section that was divided and maintains contextual information as described with respect to FIG. 3A, and according to the hierarchy 200A illustrated in FIG. 2A. Each section with contextual information of upstream sections output by the divider instructions 302 may be input to the indexing instructions 402 to generate a corresponding index entry (index entry 1, 1.1, 1.1.1, 1.1.2, 1.2). It should be noted that a given index entry for a section may be added to other index entries, such as when an inverted index is used.

For each section with contextual information, the indexing instructions 402 may cause the processor to generate an index based on the content of the section and prior context C1-C1.1.2 that the section may have retained. For example, the indexing instructions 402 may cause the processor to generate index entry 1 for section 1 having context C1 (where section 1 is a top-level section in the hierarchy). Likewise, the indexing instructions 402 may cause the processor to generate index entry 1.1 for section 1.1 having context C1 (from upstream section 1) and context C1.1 from section 1.1. Similarly, the indexing instructions 402 may cause the processor to generate index entry 1.1.1 for section 1.1.1 having context C1 and C1.1 (from upstream sections 1 and 1.1) and context C1.1.1 from section 1.1.1. The indexing instructions 402 may cause the processor to repeat such indexing for each section as a document is divided into sections or after the document has been divided into section. Because indexing instructions 402 may cause the processor to index a given section using both content from the section (including the contextual information of the section) and context of upstream sections in the hierarchy, the resulting index entries may each retain the contextual information of prior sections.

In some examples, the indexing instructions 402 may cause the processor to generate an index based on a keyword or other portion of the combined content and contextual information of a given section to be indexed. In some examples, the indexing instructions 402 may cause the processor to compress each index entry. In these examples, the index entry may be decompressed for search and retrieval.

In some examples, the indexing instructions 402 may cause the processor to store each index entry in association with a section and/or document from which the index entry was generated. Such index entries may include inverted indexes in which a given index entry may include an indexed keyword and an indication of any section of any document that includes the indexed keyword. Alternatively, the index entries may include forward indexes in which keywords of each section of each document is stored in a given index entry.

FIG. 4B shows a diagram of linear sections (sections 1-5) being indexed with the context of previous sections through execution of example indexing instructions 402. The indexing instructions 402 may index the sections 105 in a manner similar to that described with respect to FIG. 4A, except that the information indexed may contain different context information C1-C5.

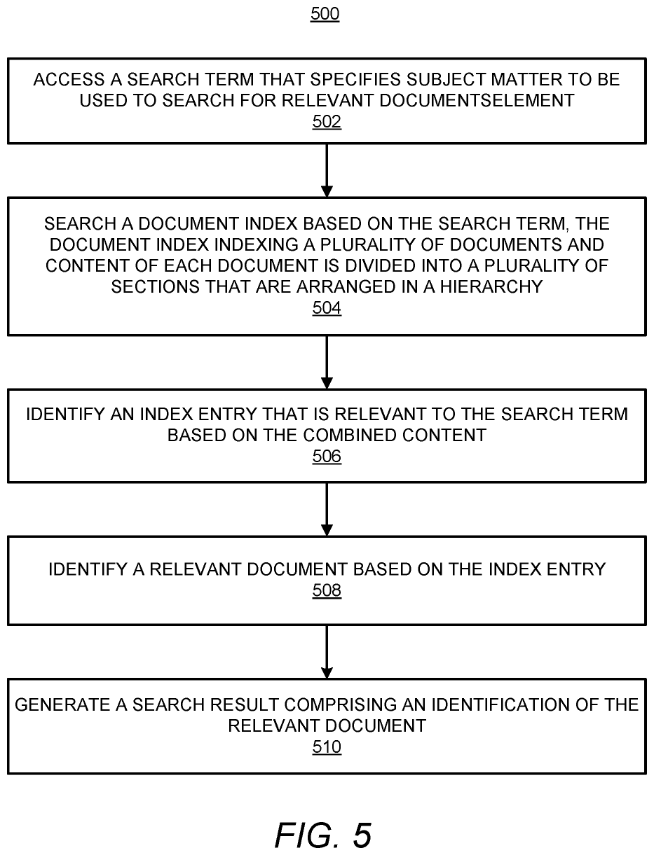

Having described dividing a document into sections and indexing the sections using contextual information, an example of using the document index to identify relevant document will now be described with reference to FIG. 5. FIG. 5 depicts a flow diagram of an example method for searching a document index that includes index entries that were generated based on document sectioning and contextual information. Various manners in which the apparatus 100 may operate to search a document index generated as disclosed herein are discussed in greater detail with respect to the method 500 depicted in FIG. 5. It should be understood that the method 500 may include additional operations and that some of the operations described therein may be removed and/or modified without departing from the scopes of the method 500. The description of the method 500 may be made with reference to the features depicted in FIGS. 1-4 for purposes of illustration.

As shown in FIG. 5, at block 502, the processor 102 may access a search term that specifies subject matter to be used to search for relevant documents. For example, the search term may include a keyword. The keyword may indicate content of interest to be found in a corpus of documents.

At block 504, the processor 102 may search a document index based on the search term. For example, the processor 102 may search for the keyword in a document index. The document index may index a plurality of documents. The content of each document from among the plurality of documents may have been divided into a plurality of sections. The sections may be arranged in a hierarchy, such as hierarchy 200A illustrated in FIG. 2A, or linearly, such as the arrangement 200B illustrated in FIG. 2B. For example, the document index may include index entries generated for the documents using the section dividing and indexing functions described herein (such as described with respect to FIGS. 3A and 4A for examples that use a hierarchy and FIGS. 3B and 4B for examples that use a linear arrangement). Each section of the plurality of sections may be associated with a corresponding index entry in the document index that includes (i.e., is generated based on) a combined content comprising content of the section and upstream context of an upstream section in the hierarchy.

At block 506, the processor 102 may identify an index entry that is relevant to the search term based on the combined content. For example, the processor 102 may use form-based index searching such as through the use of a suffix tree. Alternatively, the processor 102 may use content-based index searching, such as through the use of an inverted index. Other types of index searching may be used as well, depending on the configuration of the document index.

In some examples, a search query may include the search term and a second search term. In these examples, the processor 102 may access a second search term that specifies a domain in which to find the subject matter. To illustrate, the search term may include a keyword relating to a product and the second search term may include a keyword relating to a domain for the product, such as “financials.” Several documents and/or sections of a document/documents in the indexed plurality of documents may relate to the product. For example, a document may relate to a product and have multiple sections. The sections may relate to a description of the product, a competitive landscape for the product, and financial information for the product. These sections may be arranged hierarchically in a report or other type of document. The processor 102 may have divided the document into sections and indexed the sections into index entries.

Referring to back to FIG. 2A, for example, “section 1” in the document may relate to an overview of a company that sells the product, “subsection 1.1” may relate to “financials” of the company, subsection 1.2 may relate to description of products and services of the company, and other subsections may relate to other aspects of the company, such as competitive landscapes. Subsection 1.1.1 may relate to the product being searched for (hereinafter “target product”) and subsection 1.1.2 may relate to another product. Other subsections at this level in the hierarchy may relate to still other products or other financial information for the company. It should be noted that the target product may also appear in other sections of the document, such as under subsection 1.2 or other subsections. These other sections may be relevant to the target product if only the search term is included in the search query, but may be less relevant if the second search term is included in the search query.

The processor 102 may match the search term with content of a section and may match the second search term with contextual information from a previous section. In some of these examples, the processor 102 may match the second search term with the upstream context associated with the index entry. The processor 102 may therefore identify the index entry based on a match between the second search term and the upstream context associated with the index entry as well as the match between the search term and the context. For example, the processor 102 may match a search query that includes a search term for the target product and a second search term for “financials” (where the search query is seeking a document or section of a document that relates to financials relating to the product) with an index entry corresponding to subsection 1.1.1 of the document illustrated in the foregoing example relating to the company that sells the target product. This may be because the processor 102 may match the search term with the content of subsection 1.1.1 and match “financials” with the context of subsection 1.1 that was added to subsection 1.1.1 for indexing purposes.

At block 508, the processor 102 may identify a relevant document based on the index entry. For example, the identified index entry may be associated with or otherwise point to the relevant document. In some examples, the identified index entry may be associated with or otherwise point to the relevant document and a relevant section of the relevant document.

At block 510, the processor 102 may generate a search result comprising an identification of the relevant document. In some examples, the generated search result may an identification of a relevant section of the relevant document. The search result may be generated in response to the search query. The search result may be transmitted to a remote device (i.e., a device connected to the apparatus 100 through a network) and displayed at the remote device. As would be appreciated, the search result may include or be part of a user interface that is transmitted to or otherwise displayed by the remote device.

Some or all of the operations set forth in the method 500 may be included as utilities, programs, or subprograms, in any desired computer accessible medium. In addition, the method 500 may be embodied by computer programs, which may exist in a variety of forms. For example, some operations of the method 500 may exist as machine-readable instructions, including source code, object code, executable code or other formats. Any of the above may be embodied on a non-transitory computer readable storage medium. Examples of non-transitory computer readable storage media include computer system RAM, ROM, EPROM, EEPROM, and magnetic or optical disks or tapes. It is therefore to be understood that any electronic device capable of executing the above-described functions may perform those functions enumerated above.

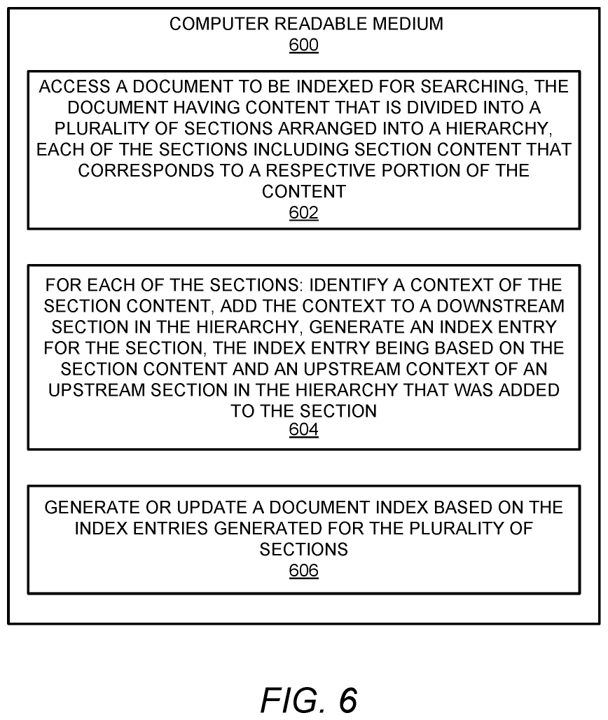

FIG. 6 depicts a block diagram of an example computer readable medium 600 for indexing a document having sections that maintain context of previous sections. The computer readable medium 600 may an electronic, magnetic, optical, or other physical storage device that includes or stores executable instructions. The computer readable medium 600 may be, for example, Random Access memory (RAM), an Electrically Erasable Programmable Read-Only Memory (EEPROM), a storage device, an optical disc, and the like. The computer readable medium 600 may be a non-transitory machine-readable storage medium, where the term “non-transitory” does not encompass transitory propagating signals. The computer readable medium 600 may have stored thereon machine-readable instructions 602-606 that a processor, such as the processor 102, may execute.

The machine-readable instructions 602 may cause the processor to access a document to be indexed for searching, the document having content that is divided into a plurality of sections arranged into a hierarchy, wherein each section of the plurality of sections includes section content that corresponds to a respective portion of the content.

The machine-readable instructions 604 may cause the processor to, for each section of the plurality of sections, identify a context of the section content, add the context to a downstream section in the hierarchy, generate an index entry for the section, the index entry based on the section content and an upstream context of an upstream section in the hierarchy that was added to the section.

The machine-readable instructions 606 may cause the processor to generate or update a document index based on the index entries generated for the plurality of sections.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration only and are not meant as limitations. Many variations are possible within the spirit and scope of the disclosure, which is intended to be defined by the following claims—and their equivalents—in which all terms are meant in their broadest reasonable sense unless otherwise indicated.

What is claimed is:

1. An apparatus comprising:
a processor; and
a non-transitory computer readable medium on which is stored instructions that when executed by the processor, are to cause the processor to:
access a document to be indexed for searching;
divide content of the document into a plurality of sections, wherein each section of the plurality of sections includes section content that corresponds to a respective portion of the content;
arrange the plurality of sections into a hierarchy;
for each section of the plurality of sections:
identify a context of the section content;
add the identified context to a downstream section in the hierarchy;
generate an index entry for the section based on the section content and an upstream context of an upstream section in the hierarchy that was added to the section; and
generate or update a document index based on the index entries generated for the plurality of sections.

2. The apparatus of claim 1, wherein to add the identified context to the downstream section in the hierarchy, the instructions are further to cause the processor to:
add the identified context to all downstream sections in the hierarchy, wherein the index entry for the section is based on the section content and the upstream context of all upstream sections in the hierarchy.

3. The apparatus of claim 1, wherein to identify the context of the section content, the instructions are further to cause the processor to:
obtain a beginning part of the section content.

4. The apparatus of claim 1, wherein to identify the context of the section content, the instructions are further to cause the processor to:
identify a title of the section content.

5. The apparatus of claim 1, wherein to divide the content of the document into the plurality of sections, the instructions are further to cause the processor to:
spatially divide the content of the document.

6. The apparatus of claim 5, wherein to spatially divide the content, the instructions are further to cause the processor to:
identify spacing of the document that indicates an organization of the document.

7. The apparatus of claim 5, wherein to spatially divide the content, the instructions are further to cause the processor to:
divide the document based on a page number, a paragraph number, or a sentence number of the content.

8. The apparatus of claim 1, wherein to divide the content of the document into the plurality of sections, the instructions are further to cause the processor to:
analyze the text of the document, wherein the content is divided based on the analysis of the text.

9. The apparatus of claim 8, wherein to analyze the text of the document, the instructions are further to cause the processor to:
identify related sub-topics based on words or phrases of the text to identify related sections and boundaries between the related sections.

10. The apparatus of claim 1, wherein to divide the content of the document into the plurality of sections, the instructions are further to cause the processor to:
identify native document structure indicators used by the document.

11. The apparatus of claim 1, wherein to divide the content of the document into the plurality of sections, the instructions are further to cause the processor to:
identify text formatting that indicates an organization of the document.

12. The apparatus of claim 1, wherein to divide the content of the document into the plurality of sections, the instructions are further to cause the processor to:
identify titles of the content in the document that indicates an organization of the document.

13. The apparatus of claim 1, wherein the first section in the hierarchy corresponds to a top-level of the document.

14. The apparatus of claim 1, wherein the instructions are further to cause the processor to:
access a search term to conduct a search of relevant documents;
search the document index based on the search term;
identify a matching index entry based on the search; and
provide a matching portion of matching content that corresponds to the matching index entry as a search result.

15. A method comprising:
accessing, by a processor, a search term that specifies subject matter to be used to search for relevant documents;
searching, by the processor, a document index based on the search term, wherein the document index indexes a plurality of documents, wherein content of each document from among the plurality of documents is divided into a plurality of sections that are arranged in a hierarchy,
wherein each section of the plurality of sections is associated with a corresponding index entry in the document index that includes a combined content comprising content of the section and upstream context of an upstream section in the hierarchy;
identifying, by the processor, an index entry that is relevant to the search term based on the combined content;
identifying, by the processor, a relevant document based on the index entry; and
generating, by the processor, a search result comprising an identification of the relevant document.

16. The method of claim 15, further comprising:
accessing a second search term that specifies a domain in which to find the subject matter; and
match the second search term with the upstream context associated with the index entry, wherein the index entry is identified based further on the match between the second search term and the upstream context associated with the index entry.

17. The method of claim 16, wherein the search result further comprises information relating to an identification of the upstream context.

18. The method of claim 15, wherein the search result further comprises a hierarchical display that includes the section corresponding to the index entry hierarchically arranged with an upstream section in the hierarchy.

19. A non-transitory computer readable medium on which is stored machine readable instructions that when executed by a processor, cause the processor to:
access a document to be indexed for searching, the document having content that is divided into a plurality of sections arranged into a hierarchy, wherein each section of the plurality of sections includes section content that corresponds to a respective portion of the content;
for each section of the plurality of sections:
identify a context of the section content;
add the context to a downstream section in the hierarchy;
generate an index entry for the section, the index entry based on the section content and an upstream context of an upstream section in the hierarchy that was added to the section; and
generate or update a document index based on the index entries generated for the plurality of sections.

20. The non-transitory computer readable medium of claim 19, wherein the instructions when executed by the processor further cause the processor to:
divide the content into the plurality of sections; and
arrange the plurality of sections into a hierarchy.
